(19) United States
(12) Patent Application Publication
(10) Pub. No.: US 2016/0373834 A1
(43) Pub. Date: Dec. 22, 2016

(54) RHYTHM BASED MULTIMEDIA GENERATOR

(71) Applicant: EMPIRE TECHNOLOGY DEVELOPMENT LLC, Wilmington, DE (US)

(72) Inventors: JUNWEI CAO, HAIDIAN DISTRICT (CN); YANXIANG XU, HAIDIAN DISTRICT (CN)

(73) Assignee: Empire Technology Development LLC

(21) Appl. No.: 14/903,922

(22) PCT Filed: Feb. 6, 2015
(86) PCT No.: PCT/CN2015/072387

§ 371 Date: Jan. 8, 2016

(51) Int. Cl. H04N 21/854; H04N 21/234; H04N 21/233; G11B 27/10; G11B 27/031

(52) U.S. Cl. CPC H04N 21/854; G11B 27/10; G11B 27/031; H04N 21/233; H04N 21/23418

(57) ABSTRACT

Technologies to generate multimedia data are generally described. In some examples, a multimedia generator may receive initial audio data that may include audio rhythm data. The audio rhythm data may be effective to indicate a pattern of a set of beats. The multimedia generator may also compare the audio rhythm data with video rhythm data, where the video rhythm data may be effective to indicate a change of direction of a set of points in a video segment. The multimedia generator may also identify the video segment based on the comparison of the audio rhythm data with the video rhythm data. The multimedia generator may also map the video segment to at least a portion of the initial audio data to generate the multimedia data.

### BACKGROUND

Unless otherwise indicated herein, the materials described in this section are not prior art to the claims in this application and are not admitted to be prior art by inclusion in this section.

Video data may be data associated with videos such as movies, personal videos, etc. Audio data may be data associated with sound such as a song, a music clip, recorded sound, etc. A combination of the video data with the audio data may result in multimedia data such that when the multimedia data is outputted, images associated with the video data and sound associated with the audio data may be presented substantially concurrently.

### SUMMARY

In some examples, methods effective to generate multimedia data are generally described. The methods may include, receiving, by a multimedia generator, initial audio data that may include audio rhythm data. The audio rhythm data may be effective to indicate a pattern of a set of beats. The methods may also include comparing, by the multimedia generator, the audio rhythm data with video rhythm data. The video rhythm data may be effective to indicate a change of direction of a set of points in a video segment. The methods may also include identifying, by the multimedia generator, the video segment based on the comparison of the audio rhythm data with the video rhythm data. The methods may also include mapping, by the multimedia generator, the video segment to at least a portion of the initial audio data to generate the multimedia data.

In some examples, systems effective to generate multimedia data are generally described. A system may include a memory that may be configured to store at least a video segment. The memory may be further configured to store video rhythm data. The video rhythm data may be effective to indicate a change of direction of a set of points in the video segment. The system may also include a processor that may be configured to be in communication with the memory. The processor may be configured to receive initial audio data. The initial audio data may include audio rhythm data. The audio rhythm data may be effective to indicate a pattern of a set of beats. The processor may also compare the audio rhythm data with the video rhythm data. The processor may also identify the video segment based on the comparison of the audio rhythm data with the video rhythm data. The processor may also map the video segment to at least a portion of the initial audio data to generate the multimedia data.

In some examples, methods to output multimedia data are generally described. The methods may include sending, by a device, initial audio data to a multimedia generator. The initial audio data may include audio rhythm data. The audio rhythm data may be effective to indicate a pattern of a set of beats. The methods may also include receiving, by the device, an indication of a video segment from the multimedia generator. The video segment may be associated with video rhythm data. The video rhythm data may be effective to indicate a change of direction of a set of points in the video segment. The video rhythm data may correspond to the audio rhythm data. The methods may also include sending, by the device, a selection of the video segment to the multimedia generator. The methods may also include receiving, by the device, the multimedia data from the multimedia generator. The multimedia data may include the video segment and the initial audio data. The methods may also include outputting, by the device, the multimedia data with use of the device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement a rhythm based multimedia generator;

FIG. 2 illustrates the example system of FIG. 1 with additional detail relating to a determination of audio rhythm data;

FIG. 3 illustrates the example system of FIG. 1 with additional detail relating to a production of video segments;

FIG. 4 illustrates the example system of FIG. 1 with additional detail relating to a generation of multimedia data;

FIG. 5 illustrates a flow diagram for an example process to implement a rhythm based multimedia generator;

FIG. 6 illustrates an example computer program product that can be utilized to implement a rhythm based multimedia generator, and

FIG. 7 is a block diagram illustrating an example computing device that is arranged to implement a rhythm based multimedia generator;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Briefly stated, technologies to generate multimedia data are generally described. In some examples, a multimedia generator may receive initial audio data that may include audio rhythm data. For example, the initial audio data may be data associated with a music clip of a duration of one minute. The audio rhythm data may be effective to indicate a pattern of a set of beats. For example, the audio rhythm data may indicate that a beat repeats at five second intervals. The multimedia generator may also compare the audio rhythm data with video rhythm data, where the video rhythm data may be effective to indicate a change of direction of a set of points in a video segment. For example, in a video, a person moving his arms up and down every five seconds may correspond to a video rhythm of five second intervals. The multimedia generator may also identify the video segment based on the comparison of the audio rhythm data with the video rhythm data. The multimedia generator may also map the video segment to at least a portion of the initial audio data to generate the multimedia data. For example, the multimedia generator may map an audio rhythm where a beat repeats at five second intervals to a video segment that indicates a person moves his arms up and down every five seconds.

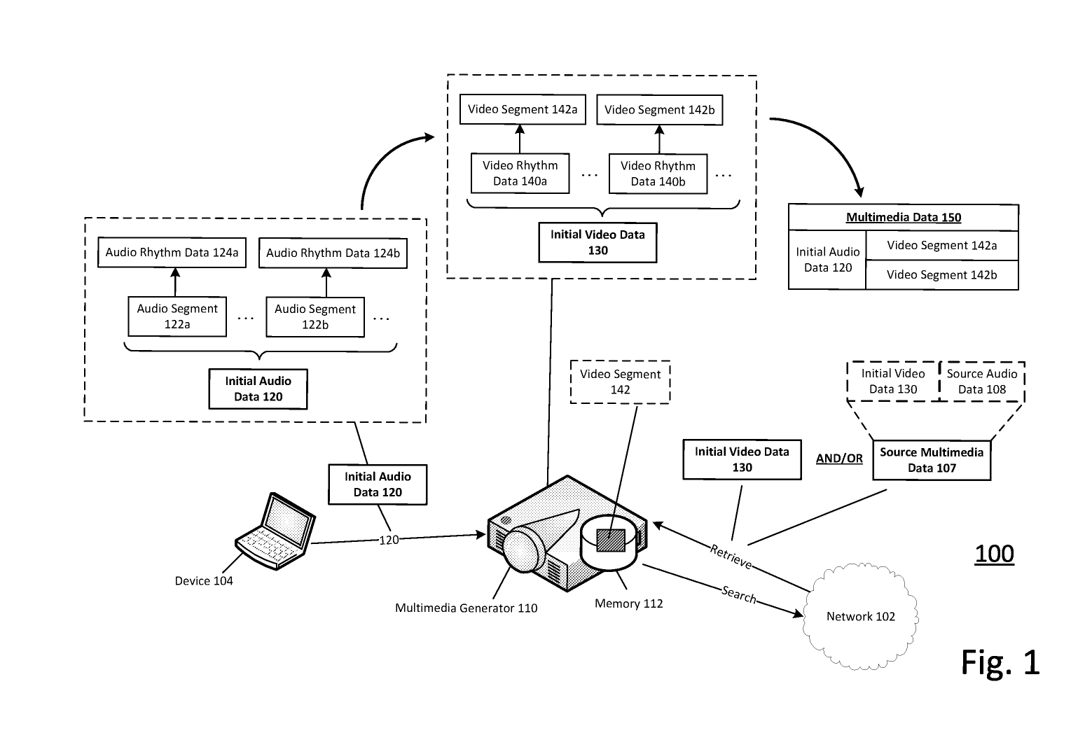

FIG. 1 illustrates an example system 100 that can be utilized to implement a rhythm based multimedia generator, arranged in accordance with at least some embodiments described herein. In some examples, system 100 may be implemented with a multimedia generator 110. As will be described in more detail below, multimedia generator 110 may be configured to receive initial audio data 120 and initial video data 130, and in response, generate multimedia data 150. Multimedia generator 110 may receive and/or retrieve initial video data 130 from a network 102, where network 102 may be a cellular network, or the Internet. Multimedia generator 110 may receive initial audio data 120 from a device 104, such as a computer or cellular phone, where device 104 may be controlled by a user. In some examples, multimedia generator 110 may receive initial audio data 120 from device 104, or a device different from device 104, through network 102. Multimedia data 150, when outputted on a display, may be a presentation of images and sound. Multimedia data 150 may include initial audio data 120 and/or video segments 142 (including video segment 142a, 142b). Each video segment among video segments 142 may be a portion of initial video data 130. Initial video data 130, when outputted on a display, may be a presentation of images without a presentation of sound. In some examples, multimedia generator 110 may receive, from network 102, source multimedia data 107 that may include initial video data 130 and source audio data 108 (that may be different from initial audio data 120), and in response, may identify and/or extract initial video data 130 from source multimedia data 107. In some examples, source multimedia data 107 may be associated with more than one multimedia presentation such as films, or movies, etc.

In an example, in response to receiving initial video data 130, multimedia generator 110 may analyze initial video data 130 in order to determine video rhythm data 140a, 140b (the determination is further described below). Video rhythm data 140 may be associated with a change of direction of a set of points, with respect to time, in video segments 142 (video rhythm data 140 is further described below). In response to the determination of video rhythm data 140, multimedia generator 110 may partition initial video data 130 to produce video segments 142a, 142b based on video rhythm data 140 (the partitioning is further described below). In response to the production of video segments 142, multimedia generator 110 may store video segments 142 and/or video rhythm data 140 in a memory 112 of multimedia generator 110.

In the example, prior to generation of multimedia data 150, multimedia generator 110 may receive initial audio data 120 from device 104. Initial audio data 120 may be digital audio data associated with audio coding format such as MP3, MIDI (Musical Instrument Digital Interface), etc. In some examples, initial audio data 120 may be effective to indicate an audio spectrum of sound. In response to the receipt of initial audio data 120, multimedia generator 110 may be configured to partition initial audio data 120 to produce audio segments 122a, 122b (the partitioning is further described below). Multimedia generator 110 may be further configured to determine audio rhythm data 124 (including audio rhythm data 124a, 124b) of audio segments 122a, 122b (the determination is further described below). Each item of audio rhythm data 124 may be effective to indicate a pattern of a set of beats (described below) in corresponding audio segments 122. In response to the determination of audio rhythm data 124, multimedia generator 110 may compare audio rhythm data 124 with video rhythm data 140, where video rhythm data 140 may be stored in memory 112. Multimedia generator 110 may identify video segments 142 based on the comparison of audio rhythm data 124 with video rhythm data 140. In response to identification of video segments 142, multimedia generator 110 may map video segments 142 to at least a portion of initial audio data 120 to generate multimedia data 150. In some examples, multimedia generator 110 may send multimedia data 150 to device 104.

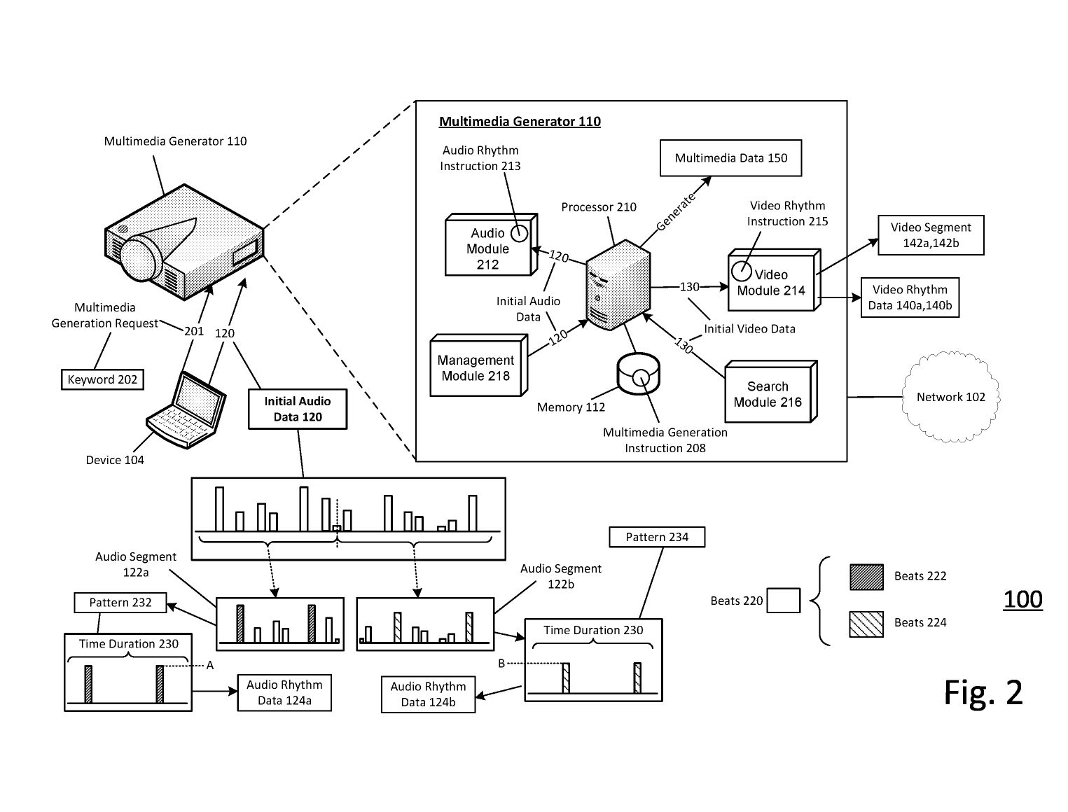

FIG. 2 illustrates the example system of FIG. 1 with additional detail relating to a determination of audio rhythm data, arranged in accordance with at least some embodiments described herein. FIG. 2 is substantially similar to system 100 of FIG. 1, with additional details. Those components in FIG. 2 that are labeled identically to components of FIG. 1 will not be described again for the purposes of clarity.

Multimedia generator 110 may include a processor 210, memory 112, an audio module 212, a video module 214, a search module 216, and/or a management module 218. Processor 210, memory 112, audio module 212, video module 214, search module 216, and/or management module 218 may be configured to be in communication with each other. In some examples, audio module 212, video module 214, search module 216, and/or management module 218 may be components of processor 210. In some examples, audio module 212, video module 214, search module 216, and/or management module 218 may each be an integrated circuit such as SoC (System on Chip), FPGA (Field-programmable Gate Array), etc.

In some examples, audio module 212, video module 214, search module 216, and/or management module 218 may each include memory modules configured to store data and/or instructions. For example, audio module 212 may store an audio rhythm instruction 213, and video module 214 may store a video rhythm instruction 215. Audio module 212 may be configured to analyze initial audio data 120 based on audio rhythm instruction 213 in order to determine audio rhythm data 124a, 124b (determination of audio rhythm data 124 is further described below). Video module 214 may be configured to analyze initial video data 130 based on video rhythm instruction 215 in order to determine video rhythm data 140a, 140b (determination of video rhythm data 140 is further described below) and identify video segments 142a, 142b. In some examples, search module 216 may be a crawler and may be configured to perform searches in network 102. Management module 218 may be configured to manage operations of system 100, such as managing user accounts, storing data in memory 112, processing instructions and/or requests from device 104, etc.

Processor 210 of multimedia generator 110 may execute multimedia generation instruction 208, where multimedia generation instruction 208 may be a set of instructions effective to generate multimedia data 150. In some examples, multimedia generator 110 may receive a search request from device 104, and in response, may instruct search module 216 to search and/or retrieve initial video data 130 from network 102. In some examples, processor 210 may be assigned, or scheduled, by an administrator of system 100 to instruct search module 216 to search and/or retrieve initial video data 130 from network 102. Search module 216 may send initial video data 130 to processor 210, and processor 210 may send initial video data 130 to video module 214. Video module 214 may receive initial video data 130 and in response, may execute video rhythm instruction 215 in order to determine video rhythm data 140. In response to determining video rhythm data 140, video module 114 may partition initial video data 130 to produce video segments 142 based on video rhythm data 140. Video module 214 may send video segments 142 to processor 210, where processor 210 may store video segments 142 in memory 112. In some examples, video module 214 may store video segment 142 in a memory module of video module 214.

In an example, device 104 may send initial audio data 120 to multimedia generator 110. In some examples, a user of system 100 may control device 104 to send initial audio data 120 to multimedia generator 110. Management module 218 of multimedia generator 110 may be configured to receive initial audio data 120 and in response, may send initial audio data 120 to processor 210. Processor 210 may receive initial audio data 120 and in response, may send initial audio data 120 to audio module 212. In some examples, a user of device 104 may select initial audio data 120 among more than one piece of audio data which may be stored in memory 112 of multimedia generator 110. Management module 218 may receive the selection of initial audio data 120, and in response, may send the selection to processor 210.

In some examples, device 104 may further send a multimedia generation request 201 to multimedia generator 110, where multimedia generation request 201 may include an indication of initial audio data 120 and may include an indication of a keyword 202. Management module 218 may receive request 201 and may identify keyword 202 from request 201. Management module 218 may instruct processor 210 to retrieve video segments 142 associated with keyword 202 from memory 112, or from video module 214. For example, when keyword 202 is a keyword “car”, management module 218 may instruct processor 210 to retrieve video segments 142 associated with “car”.

Audio module 212 may receive initial audio data 120 from processor 210 and in response, may partition initial audio data 120 to produce audio segments 122. Audio module 212 may analyze each audio segment 122 in order to determine audio rhythm data 124. In some examples, audio module 212 may partition initial audio data 120 to produce audio segments 122 based on a time duration 230, where time duration 230 may be indicated by audio rhythm instruction 213. For example, audio rhythm instruction 213 may indicate time duration 230 to be “5 seconds”. Audio module 212 may partition initial audio data 120 to produce audio segments 122 such that each audio segment 122, when outputted as sound, may have a duration of five seconds. In another example, if a total duration of initial audio data 120 is one minute and audio rhythm instruction 213 indicates time duration 230 to be “5 seconds”, audio module 212 may produce twelve items (five seconds each) of audio segments 122.

In the example depicted, audio segment 122a may include a duration of five seconds, where the duration of audio segment 122a may be from a start (zero second) to a fifth second of initial audio data 120. Audio segment 122b may include a duration of five seconds, where the duration of audio segment 122b may be from a sixth second to a tenth second of initial audio data 120. Initial audio data 120 may include one or more beats 220 and/or beats 222, 224, where a beat may be a nonzero amplitude of an audio pulse at a particular time of initial audio data 120. In some examples, beats 222, 224 may each be a subset of beats 220. In some examples, a beat may be associated with a volume of a sound. In response to the production of audio segments 122, audio module 212 may determine audio rhythm data 124a of audio segment 122a, and may determine audio rhythm data 124b of audio segment 122b. In an example, audio module 212 may analyze each audio segment among audio segments 122 to determine patterns of beats among beats 220. An analysis of audio segments 122 may include, for example, recording an amplitude of each beat among beats 220, and recording a time in which each beat occurs, within a respective audio segment 122. The analysis of audio segments 122 may further include evaluating the recorded amplitudes and recorded times of beats 220 in order to identify beats which occur in a pattern. For example, an analysis of audio segment 122a may result in an identification of beats 222 among beats 220, where beats 222 may occur at a pattern 232. Similarly, an analysis of audio segment 122b may result in an identification of beats 224 among beats 220, where beats 224 may occur at a pattern 234. As a result of the analysis on audio segments 122, audio module 212 may determine patterns 232, 234 of beats 222, 224 in audio segments 122a, 122b. For example, audio module 212 may determine that pattern 232 of beats 222 is “a beat of amplitude A at three second intervals”, and pattern 234 of beats 224 is “a beat of amplitude B at three second intervals”.

After determining patterns 232, 234 of beats 222, 224, audio module 212 may further determine audio rhythm data 124 based on patterns 232, 234. For example, audio module 212 may determine audio rhythm data 124a to be {1, 4}, which may indicate that beats 222 occurs at the first and fourth seconds of initial audio data 120. Similarly audio module 212 may determine that audio rhythm data 124b to be {7, 10}, which may indicate that beats 222 occurs at the seventh and tenth seconds of initial audio data 120. Audio module 212 may store audio segments 122 and/or audio rhythm data 124 in audio module 212 and/or may instruct processor 210 to store audio segments 122 and/or audio rhythm data 124 in memory 112.

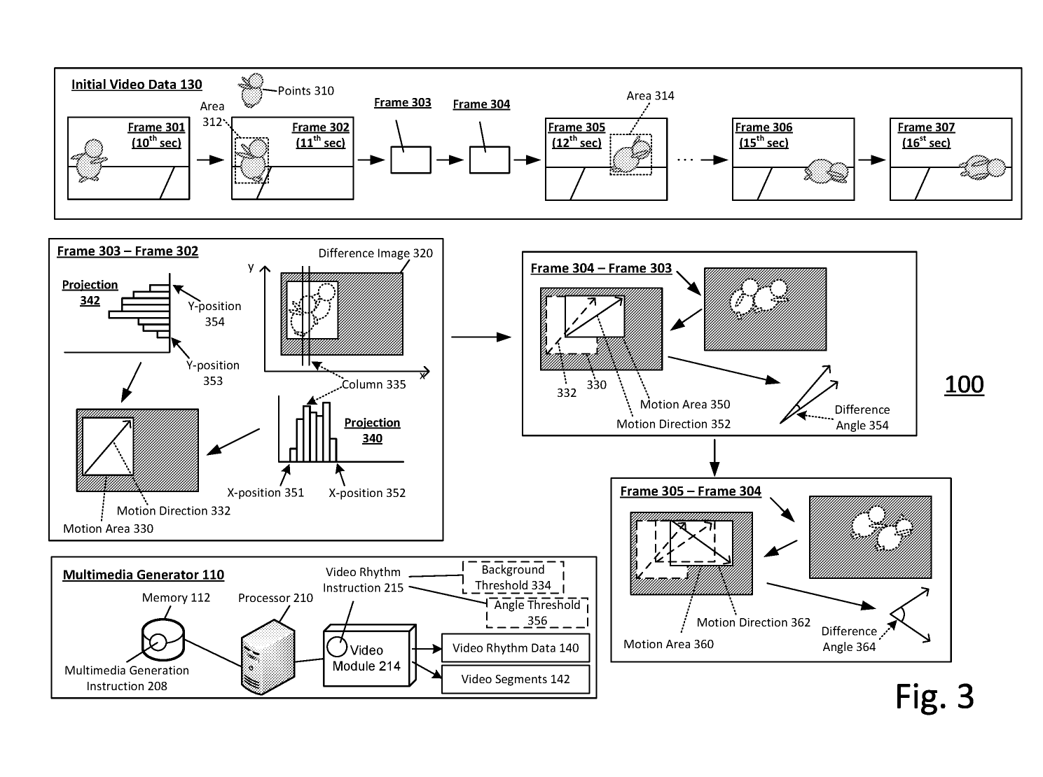

FIG. 3 illustrates the example system of FIG. 1 with additional detail relating to a production of video segments, arranged in accordance with at least some embodiments described herein. FIG. 3 is substantially similar to system 100 of FIG. 1, with additional details. Those components in FIG. 3 that are labeled identically to components of FIG. 1 will not be described again for the purposes of clarity.

As will be described in more detail below, video module 214 of multimedia generator 110 may analyze initial video data 130 in order to produce video segments 142. In some examples, an analysis of initial video data 130 may be based on video rhythm instructions 215. In some examples, video rhythm instructions 215 may be instructions associated with one or more image processing techniques such as, inter-frame differentiation, accumulative differentiation, edge detection, etc. An analysis of initial video data 130 may include determining change of direction of a set of points among frames of initial video data 130, where a frame may be associated with image data of initial video data 130 at a particular time (determination of the change of direction will be described below). Video module 214 may further determine video rhythm data 140 based on the determined change of directions (determination of video rhythm data 140 will be described below). In response to the determination of video rhythm data 140, video module 214 may partition initial video data 130 to produce video segments 142.

In the example depicted, initial video data 130 may include one or more frames 301, 302, 303, 304, 305, 306, 307, etc. Frames 301, 302, 305, 306, 307 may be associated with image data at a tenth, an eleventh, a twelfth, a fifteenth, and a sixteenth second of initial video data 130, respectively. Frames 303, 304 may be frames between frames 302, 305 and may correspond to times between the eleventh and twelfth seconds of initial video data 130. In some examples, there may be a plurality of frames, such as thirty, sixty, etc. frames between frames 302, 305, where frames 303, 304 may be among the plurality of frames. Frames 301, 302, 303, 304, 305, 306, 307 may include one or more points, such as pixels, that may correspond to images of objects. In the example, each frame among frames 301, 302, 303, 304, 305, 306, 307 may include a set of points 310, where points 310 may be effective to represent an image of an object such as a person. Points 310 may be located at different positions within boundaries of frames 301, 302, 303, 304, 305, 306, 307. For example, points 310 may be located in an area 312 within frame 302, and points 310 may be located in an area 314 within frame 305.

An analysis of initial video data 130 may include comparisons of consecutive frames of initial video data 130. For example, video module may compare frame 301 with frame 302, then may compare frame 302 with frame 303, etc. In the example, focusing on a comparison of frame 302 and frame 303, video module 214 may subtract frame 302 from frame 303 to determine a difference image 320. In some examples, prior to determining difference image 320, video module 214 may convert frames 302, 303 into grayscale images. Difference image 320 may be associated with image data that may include points 310. Video module 214 may determine a motion area 330 and a motion direction 332 based on an analysis of difference image 320, where motion area 330 and motion direction 332 may be effective to facilitate determination of video rhythm data 140.

In the example, difference image 320 may be associated with a coordinate system with a first direction “x” and a second direction “y”. Video rhythm instructions 215 may include inter-frame differentiation techniques such that video module 214 may determine a projection 340 along the x-direction and a projection 342 along the y-direction. Projection 340 along the x-direction may include determining a number of nonzero pixels in each column of pixels along the x-direction. In some examples, a nonzero pixel may correspond to a nonzero intensity value of a pixel. Projection 342 along the y-direction may include determining a number of nonzero pixels (e.g. points 310) in each row of pixels along the y-direction. For example, when difference image 320 includes one hundred pixels in the x-direction and in the y-direction, video module 214 may determine that there are forty nonzero pixels in a column 335 (or a x-position, such as x=20) of difference image 320. Video module 214 may continue to determine the number of nonzero pixels along the x-direction and the y-direction in order to determine projection 340 and projection 342.

After the determination of projection 340 and projection 342, video module 214 may determine motion area 330 and motion direction 332 based on projections 340, 342. Video module 214 may analyze projection 340 to determine a presence of nonzero pixels between x-position 351 and x-position 352. Similarly, video module 214 may analyze projection 342 to determine a presence of nonzero pixels between y-position 353 and y-position 354. Video module 214 may determine motion area 330 to be in an area bounded by x-positions 351, 352 and y-positions 353, 354. For example, when x-positions 351, 352 and y-positions 353, 354 are 10, 30, 20, 60, respectively, motion area 330 may be bounded by coordinates (10, 20), (10, 60), (30, 20), and (30, 60). Video module 214 may further determine motion direction 332 based on x-positions 351, 352 and y-positions 353, 354.

In some examples, video module 214 may determine motion direction 332 based on a sliding window technique. For example, video module 214 may fragment each frame 302, 303 into more than one color blocks, such that for example, a first color block may be associated with a foot of a person, a second color block may be associated with a hand of the person, etc. Video module 214 may identify the first and second color blocks in each of frame 302, 303 in order to determine a direction in which the person is moving. For example, if the first color block is identified at a coordinate (10, 20) in frame 302, and the first color block is identified at a coordinate (30, 60) in frame 303, video module 214 may determine a slope that corresponds to motion direction 332, such as (60−20)/(30−10)=2. In some examples, video module 214 may determine whether a background, such as areas in difference image 320 that includes zero intensity pixels, changed more than background threshold 334. Background threshold 334 may be a percentage defined by video rhythm instruction 215. When a background change is greater than background threshold 334, video module 214 may determine that there may be too many changes between frames 302, 303, and may not use frame 302 to determine video rhythm data 140. When a background change is less than background threshold 334, video module 214 may determine that frame 302 may be used in the determination of video rhythm data 140.

Video module 214 may continue to compare subsequent frames, such as comparing frame 304 with frame 303, in order to determine video rhythm data 140. Video module 214 may determine whether a background change between frames 303, 304 exceed background threshold 334. When the background change between frames 303, 304 is less than background threshold 334, video module 214 may compare frame 304 with frame 303 to determine motion area 350 and motion direction 352. Motion area 350 may be different from motion area 330, and motion direction 352 may be different from motion direction 332. Video module 214 may identify an area in which motion area 350 overlaps with motion area 330, and in response, determine a difference angle 354 between motion direction 332 and motion direction 352. Video module 214 may compare difference angle 354 with an angle threshold 356, which may be defined by video rhythm instruction 215. When difference angle 354 is less than angle threshold 356, video module 214 may continue to compare a subsequent frame, such as frame 305, with frame 304. In some examples, angle threshold 356 may be 45 degrees, 90 degrees, 180 degrees, etc.

Video module 214 may continue to compare frame 305 with frame 304 to determine motion area 360 and motion direction 362. Motion area 360 may be different from motion area 350, and motion direction 362 may be different from motion direction 352. Video module 214 may identify an area in which motion area 360 overlaps with motion area 350, and in response, determine a difference angle 364 between motion direction 352 and motion direction 362. Video module 214 may compare difference angle 364 with angle threshold 356. In the example, in response to difference angle 364 being greater than angle threshold 356, video module 214 may stop the comparison of frames in order to determine video rhythm data 140. In some examples, video module 214 may stop the comparison of frames in order to determine video rhythm data 140 in response to an absence of overlapping areas between motion areas, such as between motion areas 360, 350.

In some examples, video module 214 may determine video rhythm data 140 based on the time of frames 302, 303, 304, 305, and based on the determination of difference angles 354, 364. For example, video module 214 may determine a change of direction of points 310 based on the changes (e.g. difference angles 354, 364) among motion directions 332, 352, 362. In the example, video module 214 may determine that points 310 change between the eleventh and twelfth seconds of initial video data 130. Based on further comparison of frames, video module 214 may determine that points 310 also changes between the fourteenth and fifteenth seconds of initial video data 130. Video module 214 may determine that video rhythm data 140a may be {11, 14} to indicate that points 310 in initial video data 130 changes direction at an angle greater than angle threshold 356 at the eleventh and fourteenth second of initial video data 130. Video module 214 may partition initial video data 130 to produce video segment 142a such that video segment 142a includes frames 301, 302, 303, 304, 305, 306, and includes a duration of five seconds. Video module 214 may store video rhythm data 140a and video segment 142a in memory 112.

In some examples, video module 214 may index video segments 142 based on video rhythm data 140. For example, memory 112 may include a database indexed based on video rhythm data 140, such that video segment 142a may correspond to video rhythm data 140a and video segment 142b may correspond to video rhythm data 140b. In some examples, video module 214 may index video segments 142 based on keyword 202 in multimedia generation request 201. For example, a video segment that corresponds to cars may be indexed under a keyword of “car”, a video segment that corresponds to a cartoon may be indexed under a keyword of “cartoon” or “animation”, etc. In some examples, video module 214 may index video segments 142 based on metadata of video segments 142, such as a color, a shape, a texture, For example, a video segment that includes a sphere may be indexed under a “sphere”, a video segment that includes black and white images may be indexed under “black” and/or “white”.

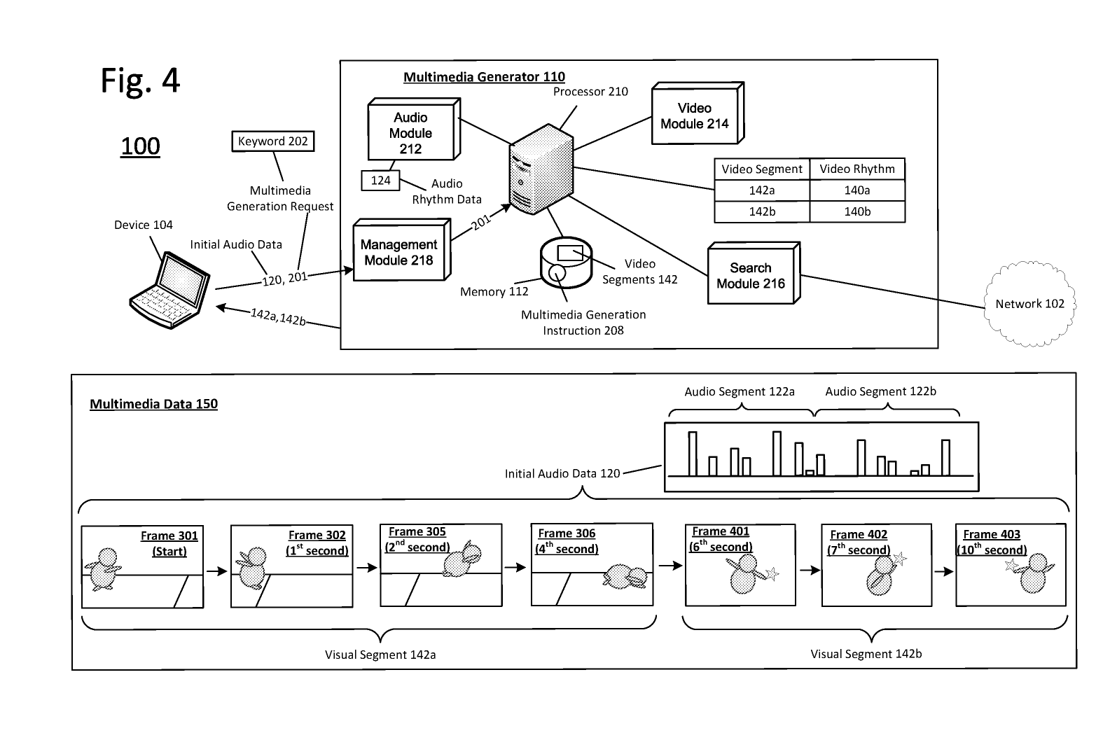

FIG. 4 illustrates the example system of FIG. 1 with additional detail relating to a generation of multimedia data, arranged in accordance with at least some embodiments described herein. FIG. 4 is substantially similar to system 100 of FIG. 1, with additional details. Those components in FIG. 4 that are labeled identically to components of FIG. 1 will not be described again for the purposes of clarity.

Generation of multimedia data 150 may begin with receiving a multimedia generation request 201 at multimedia generator 110 from device 104. In some examples, multimedia generation request 201 may include keyword 202, and may include initial audio data 120. In some examples, multimedia generation request 201 may include a selection effective to select initial audio data 120 among a list of audio data that may be stored in memory 112 of multimedia generator 110. In some examples, multimedia generation request 201 may include a search request to request search module 216 to perform a search for video data on network 102. In some examples, multimedia generation request 201 may include login credentials of a user of device 104. Management module 218 may receive multimedia generation request 201 and may be configured to validate login credentials included in multimedia generation request 201. If the login credentials are deemed invalid, management module 218 may send a response to device 104 to notify a user, or device 104, regarding the invalidated login credentials. If the login credentials are deemed valid, management module 218 may send multimedia generation request 201 to processor 210 to generate multimedia data 150.

When initial audio data 120 is not included in multimedia generation request, processor 210 may search for initial audio data 120 in memory 112 or audio module 212. In some examples, if memory 112 or audio module 212 does not include initial audio data 120, processor 210 may instruct management module 218 to notify device 104, or to request device 104 to provide initial audio data 120. In response to locating or receiving initial audio data 120, processor 210 may instruct audio module 212 to determine audio rhythm data 124. After determination of audio rhythm data 124, processor 210 may identify one or more video segments among video segments 142, which may be stored in memory 112, based on a comparison of audio rhythm data 124 and video rhythm data 140. For example, processor 210 may compare audio rhythm data 124a {1, 4} with video rhythm data 140a {11, 14}. Processor 210 may determine that audio rhythm data 124a matches with video rhythm data 140a because both audio rhythm data 124a and video rhythm data 140a indicates a rhythm of three seconds apart. In some examples, processor 210 may compare a duration of audio segment 122a with a duration of video segment 142a prior to the comparison of audio rhythm data 124a with video rhythm data 140a. For example, if video segment 142a includes a duration of seven seconds and audio segment 122a includes a duration of five seconds, processor 210 may not select video segment 142a to be used in the generation of multimedia data 150.

Processor 210 may continue to identify and/or select video segments 142 stored in memory 112 based on the comparison of audio rhythm data 124 with video rhythm data 140. In some examples, processor 210 may provide a list of the identified video segments 142 to device 104 such that device 104 may select particular video segments 142 to be used in the generation of multimedia data 150. In some examples, device 104 may select video segments 142 identified by processor 210 and may request multimedia generator 110 to send the selected video segments 142 to device 104. In the example, device 104 may select video segments 142a, 142b and may send the selection of video segments 142a, 142b to multimedia generator 110.

Multimedia generator 110 may receive the selection of video segments 142a, 142b, and in response, may map the selected video segments to at least a portion of initial audio data 120. For example, processor 210 may map video segment 142a to audio segment 122a, or to a first five seconds of initial audio data 120. Similarly, processor 210 may map video segment 142b to audio segment 122b, or to a second five seconds of initial audio data 120. As a result of the mapping, processor 210 may generate multimedia data 150 such that when multimedia data 150 is outputted, initial audio data 120 and frames 301, 302, 305, 306, 401, 402, 403 may be presented. In some examples, multimedia generator 110 may send multimedia data 150 to device 104, where multimedia data 150 may be outputted by device 104. In some examples, device 104 may request multimedia generator 110 to change particular video segments in multimedia data 150. In some examples, device 104 may request multimedia generator 110 to store multimedia data 150 in memory 112. In some examples, device 104 may request multimedia generator 110 to upload multimedia data 150 to network 102. In some examples, device 104 may create a profile, such as a title and description, of multimedia data 150 and may request multimedia generator 110 to store the created profile.

Among other possible benefits, a system in accordance with the disclosure may generate multimedia data that includes matching audio rhythm and video rhythm. A user of the system may produce personal movies or music videos with a song or music clip without a need to search for matching video segments of videos. Further, the user of the system may not be burdened with the task of partitioning video data to produce video segments since the system may be configured to partition the video data, and may store the produced video segments.

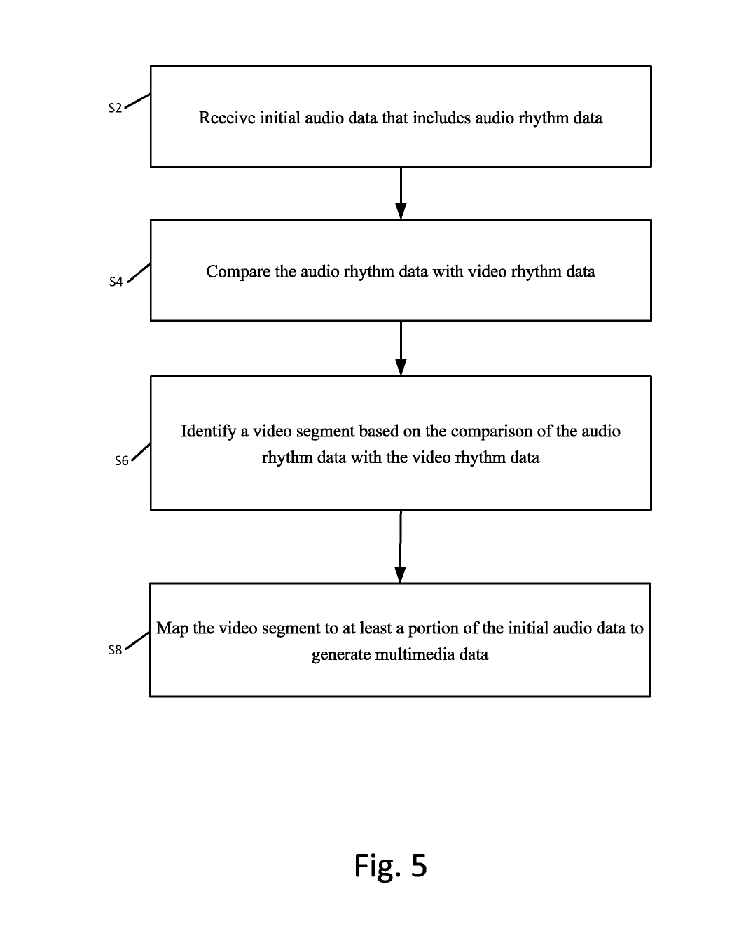

FIG. 5 illustrates a flow diagram for an example process to implement a rhythm based multimedia generator, arranged in accordance with at least some embodiments presented herein. The process in FIG. 5 could be implemented using, for example, system 100 discussed above. An example process may include one or more operations, actions, or functions as illustrated by one or more of blocks S2, S4, S6, and/or S8. Although illustrated as discrete blocks, various blocks may be divided into additional blocks, combined into fewer blocks, or eliminated, depending on the desired implementation.

Processing may begin at block S2, “Receive initial audio data that includes audio rhythm data”. At block S2, A multimedia generator may receive initial audio data, where the initial audio data may include audio rhythm data. The audio rhythm data may be effective to indicate a pattern of a set of beats of the initial audio data. In some examples, the multimedia generator may partition the initial audio data to produce an audio segment. The multimedia generator may analyze the audio segment. The multimedia generator may determine the pattern of the set of beats based on the analysis of the audio segment. The multimedia generator may determine the audio rhythm data based on the pattern of the set of beats.

Processing may continue from block S2 to block S4, “Compare the audio rhythm data with video rhythm data”. At block S4, the multimedia generator may compare the audio rhythm data with the video rhythm data. The video rhythm data may be effective to indicate a change of direction of a set of points in a video segment. In some examples, prior to receiving the initial audio data, the multimedia generator may receive initial video data that may include the video segment. The multimedia generator may determine the change of direction of the set of points in the initial video data. The determination of the change of direction may be based on an analysis of the initial video data and/or the video segment. The multimedia generator may determine the video rhythm data based on the change of direction of the set of points. The multimedia generator may partition the initial video data to produce the video segment based on the video rhythm data. The multimedia generator may store the video segment in a memory. In some examples, the audio segment may be associated with a duration. The multimedia generator may select the video rhythm data based on the duration prior to comparing the audio rhythm data with the video rhythm data.

Processing may continue from block S4 to block S6, “Identify a video segment based on the comparison of the audio rhythm data with the video rhythm data”. At block S6, the multimedia generator may identify the video segment based on the comparison of the audio rhythm data with the video rhythm data. In some examples, the multimedia generator may receive a request from a device prior to identifying the video segment. The request may include the initial audio data and may include a keyword associated with the video segment. The multimedia generator may identify the video segment based on the keyword.

Processing may continue from block S6 to block S8, “Map the video segment to at least a portion of the initial audio data to generate multimedia data”. At block S8, the multimedia generator may map the video segment to at least a portion of the initial audio data to generate the multimedia data. In some examples, the initial audio data may be received at the multimedia generator from a device. The multimedia generator may send the multimedia data to the device after generation of the multimedia data.

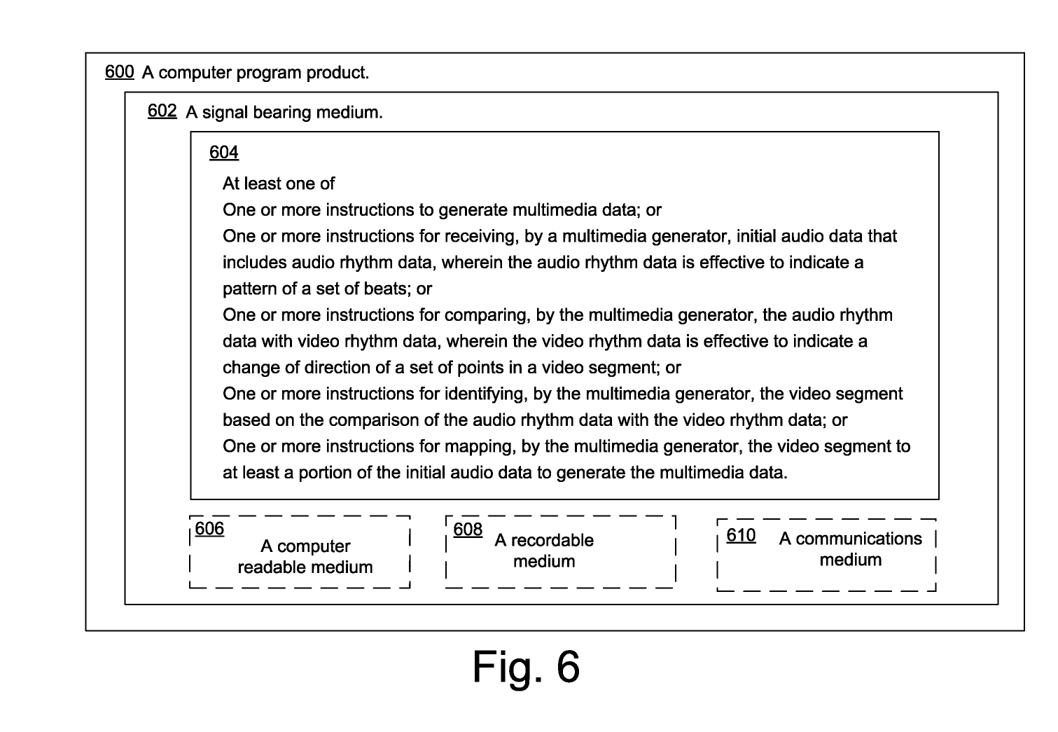

FIG. 6 illustrates an example computer program product that can be utilized to implement a rhythm based multimedia generator, arranged in accordance with at least some embodiments described herein. Program product 600 may include a signal bearing medium 602. Signal bearing medium 602 may include one or more instructions 604 that, when executed by, for example, a processor, may provide the functionality described above with respect to FIGS. 1-5. Thus, for example, referring to system 100, processor 210 of multimedia generator may undertake one or more of the blocks shown in FIG. 5 in response to instructions 604 conveyed to the system 100 by medium 602.

In some implementations, signal bearing medium 602 may encompass a computer-readable medium 606, such as, but not limited to, a hard disk drive, a Compact Disc (CD), a Digital Video Disk (DVD), a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, program product 600 may be conveyed to one or more modules of the system 100 by an RF signal bearing medium 602, where the signal bearing medium 602 is conveyed by a wireless communications medium 610 (e.g., a wireless communications medium conforming with the IEEE 802.11 standard).

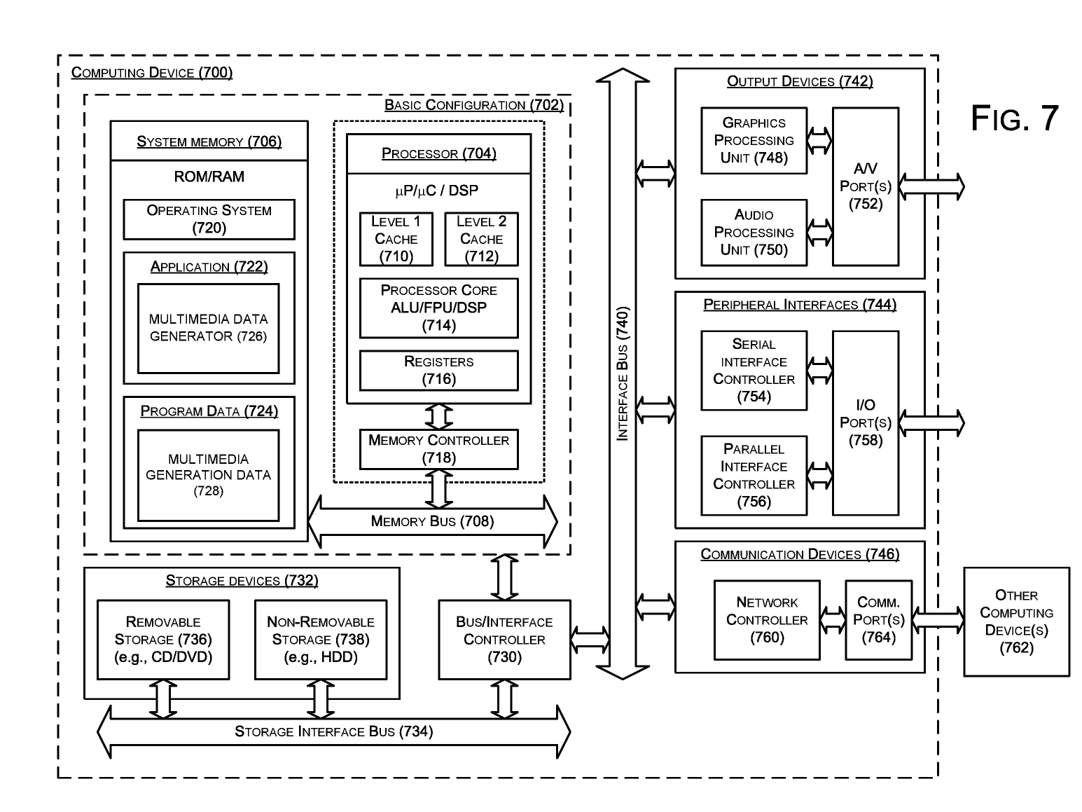

FIG. 7 is a block diagram illustrating an example computing device 700 that is arranged to implement a rhythm based multimedia generator, arranged in accordance with at least some embodiments described herein. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include a multimedia data generator 726 that is arranged to perform the functions as described herein including those described with respect to system 100 of FIGS. 1-6. Program data 724 may include multimedia generation data 728 that may be useful for implementation of a rhythm based multimedia generator as is described herein. In some embodiments, application 722 may be arranged to operate with program data 724 on operating system 720 such that implementations of a rhythm based multimedia generator may be provided. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM. ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will also be understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to generate multimedia data, the method comprising:
receiving, by a multimedia generator, initial audio data that includes audio rhythm data, wherein the audio rhythm data is effective to indicate a pattern of a set of beats;
comparing, by the multimedia generator, the audio rhythm data with two or more pieces of video rhythm data, wherein the each piece of video rhythm data corresponds to a respective video segment among two or more video segments, and each piece of video rhythm data is effective to indicate a change of direction of a set of points in a respective video segment;
identifying, by the multimedia generator, a video segment among the two or more video segments based on the comparison of the audio rhythm data with the two or more pieces of video rhythm data; and
mapping, by the multimedia generator, the identified video segment to at least a portion of the initial audio data to generate the multimedia data.

2. The method of claim 1, further comprising, prior to receiving the initial audio data:
receiving initial video data that includes the two or more video segments;
determining a change of direction of a set of points in a particular video segment based on an analysis of the initial video data;
determining the two or more pieces of video rhythm data based on the change of direction of the set of points in the particular video segment;
partitioning the initial video data to produce the two or more video segments based on the two or more pieces of video rhythm data; and
storing the two or more video segments in a memory.

3. The method of claim 2, wherein determining the change of direction of the set of points in the particular video segment includes:
comparing a first frame of the initial video data with a second frame of the initial video data, wherein the first frame corresponds to a first time, the second frame corresponds to a second time, the first frame includes the set of points in a first area of the particular video segment, the second frame includes the set of points in a second area of the particular video segment;
determining a difference between the first frame and the second frame;
determining a motion area between the first frame and the second frame based on the difference; and
determining a direction of the set of points in the particular video segment based on an analysis of the motion area, wherein determining the change of direction of the set of points in the particular video segment is based on the direction of the set of points in the particular video segment.

4. The method of claim 3, wherein the motion area is a first motion area, the difference is a first difference, and the direction is a first direction, the method further comprising:
determining a second difference between a third frame and the second frame;
determining a second motion area between the second frame and the third frame based on the second difference;
determining a second direction of the set of points in the particular video segment based on an analysis of the second motion area;
comparing the first direction with the second direction; and
determining a difference angle based on the comparison of the first direction with the second direction, wherein determining the two or more pieces of video rhythm data is based on the difference angle.

5. The method of claim 1, wherein the initial audio data is received from a device, and the method further comprises:
sending at least a portion of the identified video segment to the device; and
receiving a selection from the device, wherein the selection is a selection of the video segment; and
wherein mapping the identified video segment to the initial audio data is performed in response to the receipt of the selection.

6. The method of claim 1, further comprising, prior to identifying the video segment:
partitioning the initial audio data to produce an audio segment;
analyzing the audio segment;
determining the pattern of the set of beats based on the analysis of the audio segment; and
determining the audio rhythm data based on the pattern of the set of beats.

7. The method of claim 6, wherein the audio segment is associated with a duration, and the method further comprises, selecting the two or more pieces of video rhythm data based on the duration prior to comparing the audio rhythm data with the two or more pieces of video rhythm data.

8. The method of claim 1, further comprising:
receiving a request from a device prior to identifying the video segment, wherein the request includes the initial audio data and a keyword associated with the video segment; and
identifying the video segment is further based on the keyword.

9. The method of claim 1, wherein the initial audio data is received from a device, and the method further comprises sending the multimedia data to the device.

10. The method of claim 1, wherein the audio rhythm data is first audio rhythm data, the initial audio data further includes second audio rhythm data, the pattern is a first pattern, the set of beats is first set of beats, the two or more pieces of video rhythm data include first video rhythm data and second video rhythm data, the two or more video segments include a first video segment, the first video rhythm data is effective to indicate a first change of direction of a first set of points, in the first video segment, and the method further comprises:
comparing second audio rhythm data with the second video rhythm data, wherein the second audio rhythm data is effective to indicate a second pattern of a second set of beats, the second pattern is different from the first pattern, the second set of beats is different from the first set of beats, the second video rhythm data is effective to indicate a second change of direction of a second set of points in a second video segment, the second change of direction is different from the first change of direction, and the second set of points is different from the first set of points;
identifying a second video segment among the two or more video segments based on the comparison of the second audio rhythm data with the two or more pieces of video rhythm data; and
mapping the second video segment to a second audio segment of the initial audio data to generate the multimedia data.

11. A system effective to generate multimedia data, the system comprising:
a memory being configured to:
store two or more video segments; and
store two or more pieces of video rhythm data, wherein each piece of video rhythm data corresponds to a respective video segment among the two or more video segments, and each piece of video rhythm data is effective to indicate a change of direction of a set of points in a respective video segment;
a processor configured to be in communication with the memory, the processor being configured to:
receive initial audio data that includes audio rhythm data, wherein the audio rhythm data is effective to indicate a pattern of a set of beats;
compare the audio rhythm data with the two or more pieces of video rhythm data;
identify the video segment among the two or more video segments based on the comparison of the audio rhythm data with the two or more pieces of video rhythm data; and
map the identified video segment to at least a portion of the initial audio data to generate the multimedia data.

12. The system of claim 11, further comprising a video module configured to be in communication with the processor and the memory, the video module being configured to:
receive initial video data that includes the two or more video segments;
compare a first frame of the initial video data with a second frame of the initial video data, wherein the first frame corresponds to a first time, the second frame corresponds to a second time, the first frame includes the set of points in a first area in a particular video segment, the second frame includes the set of points in a second area in the particular video segment;
determine a difference between the first frame and the second frame;
determine a motion area between the first frame and the second frame based on the difference;
determine a direction of the set of points in the particular video segment based on an analysis of the motion area, wherein determining the change of direction of the set of points in the particular video segment is based on the direction of the set of points in the particular video segment;
determine the two or more pieces of video rhythm data based on the change of direction of the set of points in the particular video segment;
partition the initial video data to produce the two or more video segments based on the two or more pieces of video rhythm data; and
store the two or more video segments in the memory.

13. The system of claim 12, wherein the motion area is a first motion area, the difference is a first difference, and the direction is a first direction, the video module is further configured to:
determine a second difference between a third frame and the second frame;
determine a second motion area between the second frame and the third frame based on the second difference;
determine a second direction of the set of points in the particular video segment based on an analysis of the second motion area;
compare the first direction with the second direction; and
determine a difference angle based on the comparison of the first direction with the second direction, wherein determining the two or more pieces of video rhythm data is based on the difference angle.

14. The system of claim 11, further comprising an audio module configured to be in communication with the processor and the memory, the audio module being configured to:
partition the initial audio data to produce an audio segment prior to the identification of the video segment;
analyze the audio segment;
determine the pattern of the set of beats based on the analysis of the audio segment; and
determine the audio rhythm data based on the pattern of the set of beats.

15. The system of claim 14, wherein the audio segment is associated with a duration, and the processor is further configured to select the two or more pieces of video rhythm data based on the duration prior to the comparison of the audio rhythm data with the two or more pieces of video rhythm data.

16. The system of claim 11, wherein the processor is further configured to receive a request from a device prior to the identification of the video segment, wherein the request includes the initial audio data and a keyword associated with the video segment, and the identification of the video segment is further based on the keyword.

17. The system of claim 11, wherein the initial audio data is received from a device, and the processor is further configured to send the multimedia data to the device.

18. A method to output multimedia data, the method comprising, by a device:
sending initial audio data to a multimedia generator, wherein the initial audio data includes audio rhythm data, and the audio rhythm data is effective to indicate a pattern of a set of beats;
receiving an indication of two or more video segments from the multimedia generator, wherein the each video segment corresponds to respective video rhythm data among two or more pieces of video rhythm data, and each piece of video rhythm data is effective to indicate a change of direction of a set of points in a respective video segment;
sending a selection of a video segment among the two or more video segments to the multimedia generator;
receiving the multimedia data from the multimedia generator, wherein the multimedia data includes the selected video segment and the initial audio data; and
outputting the multimedia data with use of the device.

19. The method of claim 18, wherein sending the initial audio data to the multimedia generator includes sending a keyword associated with the two or more video segments.

20. The method of claim 19, further comprising, sending an instruction to the multimedia generator to search for initial video data based on the keyword, wherein the initial video data includes the two or more video segments.
